(19) United States
(12) Patent Application Publication
(10) Pub. No.: US 2005/0148298 A1
(43) Pub. Date: Jul. 7, 2005

(54) Channel quality evaluation method applicable to bluetooth wireless network

(76) Inventors: Kuang-Ping Ma, Hsinchu (TW); Yao-Chun Yu, Hsinchu (TW); Chung-I Lee, Hsinchu (TW); Albert Chen, Hsinchu (TW)

Correspondence Address: BIRCH STEWART KOLASCH & BIRCH, PO BOX 747, FALLS CHURCH, VA, 22040-0747, US

(21) Appl. No.: 10/751,975

(22) Filed: Jan. 7, 2004

(51) Int. Cl. H04B 7/00

(52) U.S. Cl. 455/41.2

(57) ABSTRACT

A channel quality evaluation method applicable to Bluetooth wireless network sends a first channel detecting format packet from the Bluetooth master to the Bluetooth slave. The master verifies if the slave recognizes the first channel detecting format packet from the response from the slave. If the Bluetooth slave does not recognize the first format detecting packet, the Bluetooth master will send a second channel detecting format packet. The error rate is to be calculated according to the response from the Bluetooth slave to obtain an estimate of the channel qualify. This method obtains the channel quality efficiently and does not interfere with the normal operation of the Bluetooth devices.

### BACKGROUND OF THE INVENTION

1. Field of Invention

The invention is related to a channel quality evaluation method for wireless network, especially a channel quality evaluation method applicable to Bluetooth wireless network.

2. Related Art

In a co-exist environment having Bluetooth wireless network and other standard wireless network, interferences between different wireless devices can visibly reduce transmission speed. Since Bluetooth system uses spread spectrum modulation and frequency hopping is its frequency spreading method, interferences can be avoided by using a Bluetooth device to skip channels that are used by other wireless devices. However, to effectively omit the used channels, channel usages need to be identified beforehand. The current Bluetooth standard does not specify the method for evaluating channel quality; they are determined by the manufacturers. It should reference to Bluetooth specification 1.1 and 1.2 (the specifications can be found in www.bluetooth.com). The usual convention uses the following methods for channel quality evaluation:

1. received signal strength (RSS);

2. carrier sensing (CS); and

3. error rate (ER).

The first method, RSS, has the advantage of simple structure, and its disadvantage is its difficulty to identify the strength threshold of the receiving signal between the usable and unusable channels. The second method, CS, has the advantage of high accuracy and the disadvantage of being expensive due to the additional packet detector inserted into the Bluetooth receiver for detecting other wireless devices. Therefore, if interferences come from packets generated by a wireless device undetectable by the extra packet detector (such as noise), it is still undetectable. The advantage of the third method, ER, is its high accuracy; yet, its disadvantages include having an error rate calculation that cannot be clearly defined, and a compatibility problem between different manufacturers. Therefore, to effectively retrieve channel quality without disturbing the Bluetooth operation is an important issue.

### SUMMARY OF THE INVENTION

To solve the described technical problem, this invention reveals a channel quality evaluation method applicable to Bluetooth wireless network, providing a more accurate channel quality evaluation and simultaneously solving the compatibility problem between Bluetooth devices produced by different manufacturers.

To achieve the described goal, this invention provides a channel evaluation method applicable to Bluetooth wireless network. First, the Bluetooth master device transmits a first channel detecting format packet to the Bluetooth slave device. According to the response from the Bluetooth slave, it can be determined if the slave recognizes the first channel detecting format packet. If the Bluetooth slave cannot recognize the first channel detecting format packet, the Bluetooth master device will transmit a second channel detecting format packet. Finally, the master executes error rate calculation and obtains the channel quality evaluation according to the response from the Bluetooth slave device.

This invention uses the three channel evaluating methods from known technology. By using the special design of first channel detecting format packet, it obtains a more accurate channel quality evaluation. Also, the design of second channel detecting format packet solves the compatibility problem between Bluetooth devices made by different manufacturers.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow for illustration only, and thus are not limitative of the present invention, and wherein:

FIG. 1 illustrates the flow chart of the invention of a channel quality evaluation method applicable to Bluetooth wireless network.

FIG. 2 illustrates the first channel quality detecting packet format.

FIG. 3 illustrates the operation of the second channel quality detecting packet format.

FIG. 4 illustrates the operation of the first channel quality detecting format packet to a Bluetooth device that can recognize the packet.

FIG. 5 illustrates the operation of the first channel quality detecting format packet to a Bluetooth device that cannot recognize the packet.

### DETAILED DESCRIPTION OF THE INVENTION

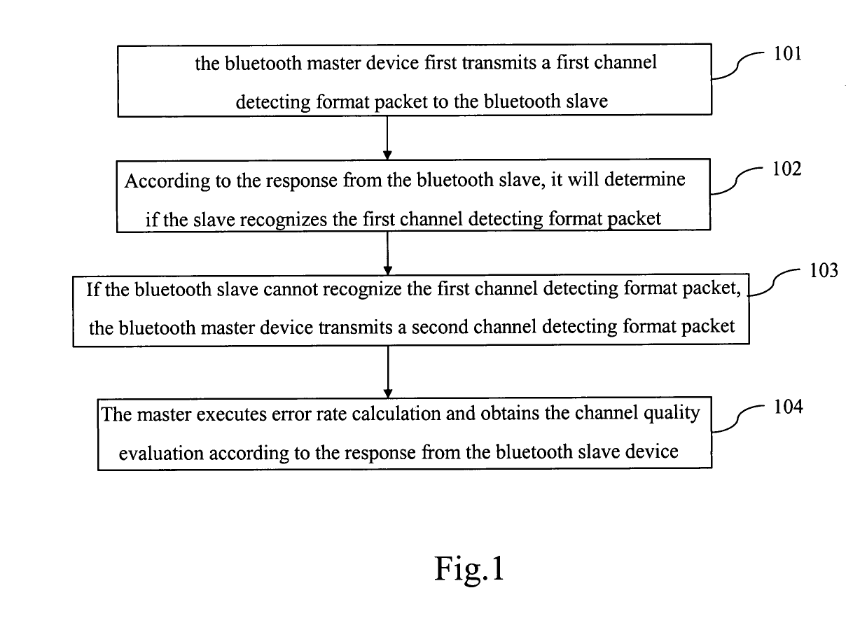

As shown in FIG. 1, which illustrates the flow chart of the invention of channel quality evaluation method applicable to Bluetooth wireless network, the Bluetooth master device first transmits a first channel detecting format packet to the Bluetooth slave (step 101).

According to the response from the Bluetooth slave, it will determine if the slave recognizes the first channel detecting format packet (step 102). If the Bluetooth slave cannot recognize the first channel detecting format packet, the Bluetooth master device transmits a second channel detecting format packet (step 103). The master executes error rate calculation and obtains the channel quality evaluation according to the response from the Bluetooth slave device (step 104).

In the Bluetooth system, when a Bluetooth slave device receives a POLL packet, it returns a NULL packet to the Bluetooth master device. This characteristic can be used to calculate the bit error rate (BER) or packet error rate (PER) for evaluating channel quality. The advantage of this method is that there exists no compatibility problem so that all Bluetooth devices can be operated under this protocol. The disadvantage is the fact that its short packet size will result in a less accurate error rate calculation. The packet combination of POLL and NULL packets is called the second channel detecting packet format.

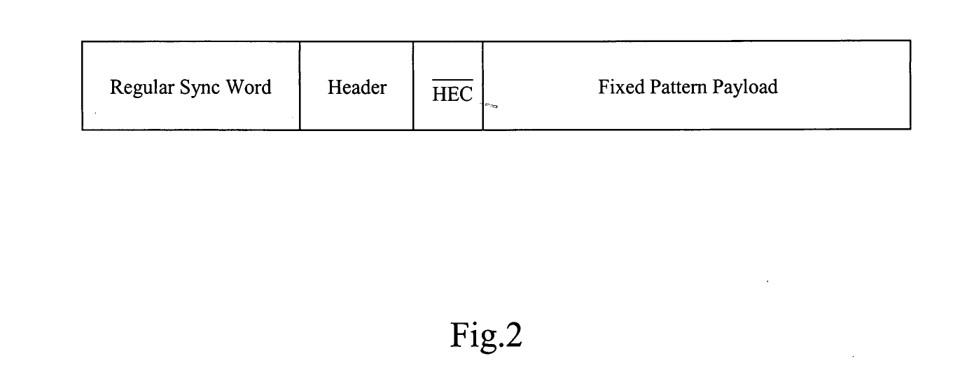

In a Bluetooth packet, the header error checking (HEC) is used to verify the accuracy of the packet header. If the error checking result is true, the decoding operations will be engaged. However, if the error checking result is false, the decoding operation will be halted. Using this characteristic, by modifying the HEC to a specified value and placing a consistent data as the payload, a special channel detecting packet can be generated. This invention called such packet format as the first channel detecting packet format. Bluetooth devices that can recognize this packet format is called device A, and the ones that cannot recognize it is called B. There is no limitation for choosing the special HEC; any special HEC value can be used. As shown in FIG. 2, the special HEC value that is obtained by inverting the original HEC is a valid value.

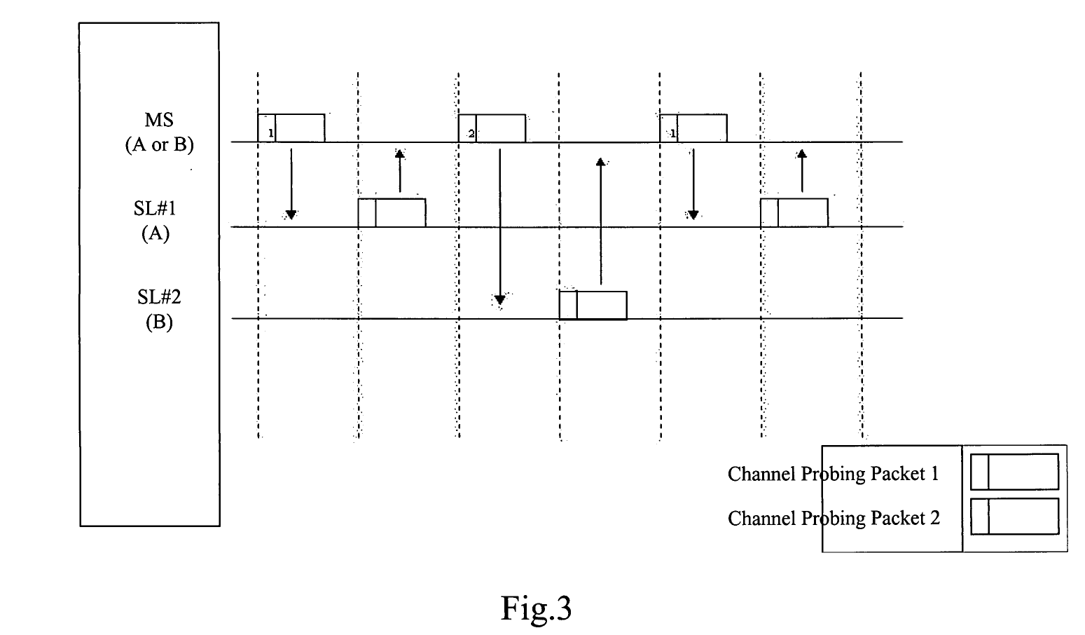

When applying the two aformentioned channel detecting packet formats into the actual operation, they solve the following possible situations. As shown in FIG. 3, when the Bluetooth master transmits only the second channel detecting format packet to a Bluetooth slave device that has the ability to recognize the first channel detecting format packet (device SL#1 in FIG. 3), it is able to use the packet to execute channel quality evaluation. While this packet format is fully compatible with the Bluetooth specifications, bluetooth slave device that cannot recognize the first channel detecting format packet (device SL#2 in FIG. 3) can also receive this packet and returns a NULL packet to the bluetooth master device. In this situation, there presents no compatibility problem in the actual operations.

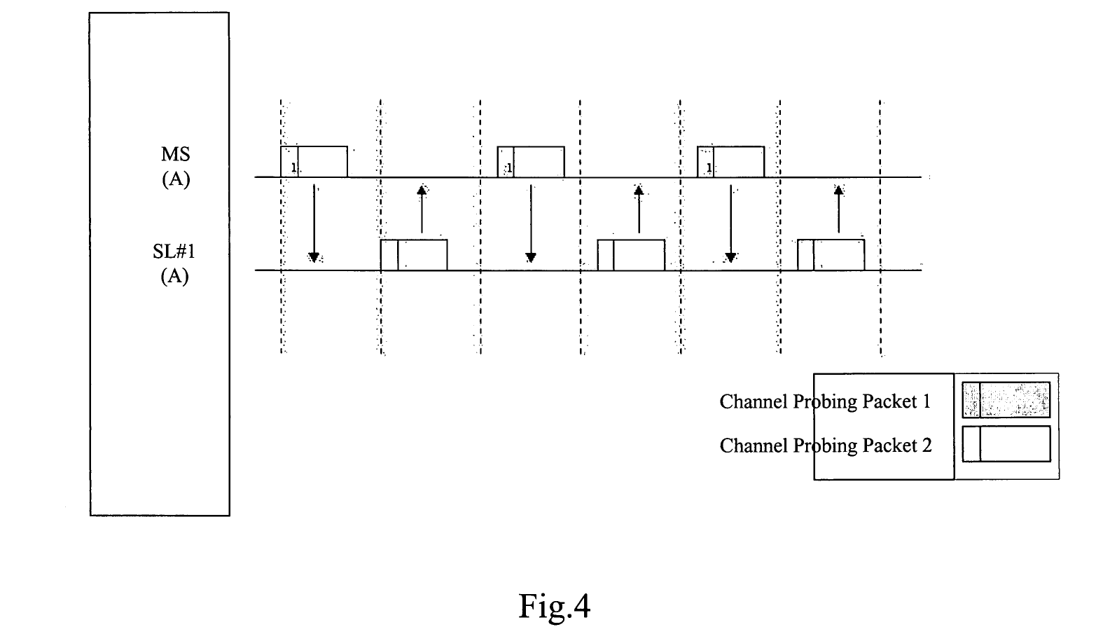

As shown in FIG. 4, when Bluetooth master transmits the first channel detecting format packet to a Bluetooth slave device that has the ability to recognize this channel detecting packet, the slave can use the long payload data of the packet to execute the more accurate error rate calculation to obtain a better channel quality evaluation. Also, since the Bluetooth slave now realizes that the Bluetooth master is a Bluetooth device which recognizes the first channel quality detecting packet, and that the Bluetooth master wants to execute channel quality evaluation, the Bluetooth slave will return a first channel quality detecting format packet to the Bluetooth master so that the master can also calculate channel quality evaluation.

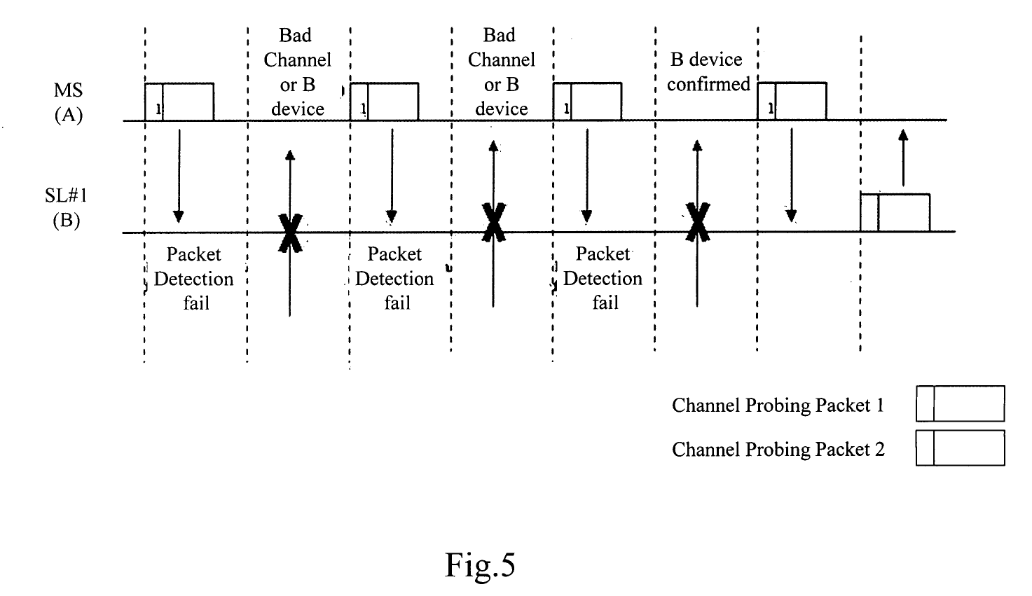

As shown in FIG. 5, when Bluetooth master transmits the first channel detecting format packet, if this Bluetooth slave does not have the ability to recognize the first channel detecting format packet and the special HEC, the Bluetooth slave stops the decoding operation and will not respond to the Bluetooth master. Most of the time, the Bluetooth master does not receive a response due to undetermined reasons, which may be caused by packet lost (bad channel) or the fact that the Bluetooth slave is not the one that can recognize the first channel detecting format packet. Thus, to verify the cause of the packet loss, the Bluetooth master device sends the first channel detecting format packets on different channels. If the Bluetooth master still receives no response after a specified amount of attempts, it will be confirmed that the Bluetooth slave is not the one that recognizes the first channel detecting format packet and it will switch to the second channel detecting format packet to execute channel quality evaluation.

The invention being thus described will become obvious that the same may be varied in many ways. Such variations are not to be regarded as a departure from the spirit and scope of the invention, and all such modifications as would be obvious to one skilled in the art are intended to be included within the scope of the following claims.

1. A channel quality evaluation method applicable to Bluetooth wireless network comprises of the following steps:
transmitting a first channel detecting format packet to a Bluetooth slave device from a Bluetooth master device;
determining from the response of said Bluetooth slave device if it recognizes the first channel detecting format packet;
when said Bluetooth slave device does not recognize said first channel detecting format packet, said Bluetooth master device transmitting a second channel detecting format packet; and
calculating error rate and obtaining channel quality evaluation according to the response from said Bluetooth slave device.

2. The channel quality evaluation method applicable to Bluetooth wireless network as described in claim 1, wherein said first channel detecting format packet modifies the header error checking (HEC) field in a Bluetooth packet to a special value and places a consistent payload data to form a channel detecting packet format.

3. The channel quality evaluation method applicable to Bluetooth wireless network as described in claim 1, wherein said Bluetooth slave device receives said first channel detecting format packet, if it recognizes said special value in said packet, it will return a channel detecting packet with the same format to said Bluetooth master device; it is also verified that said Bluetooth slave device can recognize said first channel detecting format packet.

4. The channel quality evaluation method applicable to Bluetooth wireless network as described in claim 1, wherein said Bluetooth slave device receives said first channel detecting format packet, if it does not recognize said special value in said first format packet, it will not respond; it is verified that said Bluetooth slave device cannot recognize first channel detecting format packet.

5. The channel quality evaluation method applicable to Bluetooth wireless network as described in claim 1, wherein said Bluetooth master device transmits a first channel detecting format packet, if no response is received from said Bluetooth slave device, said Bluetooth master device will retransmit said first channel detecting format packet on different channels; if response is never received after a predetermined value, it is verified that said Bluetooth slave device cannot recognize said first channel detecting format packet.

6. The channel quality evaluation method applicable to Bluetooth wireless network as described in claim 1, wherein said second channel detecting format packet includes said Bluetooth master device transmitting a POLL packet, and said Bluetooth slave device receiving said POLL packet and returning a NULL packet.

7. The channel quality evaluation method applicable to Bluetooth wireless network as described in claim 1, wherein said step of calculating error rate and obtaining channel quality evaluation according to the response from said Bluetooth slave device, when said Bluetooth slave device returns a first channel detecting format packet, the payload data of said detecting packet is used to execute error calculation to obtain channel quality evaluation.

8. The channel quality evaluation method applicable to Bluetooth wireless network as described in claim 1, wherein said step of calculating error rate and obtaining channel quality evaluation according to the response from said Bluetooth slave device, when said Bluetooth slave device returns a NULL packet, POLL packet and NULL packet are used to execute error calculation to obtain channel quality evaluation.

9. The channel quality evaluation method applicable to Bluetooth wireless network as described in claim 1, wherein said error rate calculation implements the bit error rate (BER) calculation.

10. The channel quality evaluation method applicable to Bluetooth wireless network as described in claim 1, wherein said error rate calculation implements the packet error rate (PER) calculation.
